(19) United States
(12) Patent Application Publication
(10) Pub. No.: US 2023/0045013 A1
(43) Pub. Date: Feb. 9, 2023

(54) METHODS AND SYSTEMS FOR FACILITATING MANAGING STUDENT ATTENDANCE AND MOVEMENT OF INDIVIDUALS THROUGHOUT A SCHOOL FACILITY

(71) Applicant: SchoolPass, Inc., Gaithersburg, MD (US)

(72) Inventors: Mark Ruiters, Gaithersburg, MD (US); Sam Rosenfeld, Greenwich, CT (US)

(21) Appl. No.: 17/969,563

(22) Filed: Oct. 19, 2022

Related U.S. Application Data
(63) Continuation-in-part of application No. 17/843,519, filed on Jun. 17, 2022, now abandoned.
(60) Provisional application No. 63/211,839, filed on Jun. 17, 2021.

(51) Int. Cl. G06Q 50/20; G06K 7/10

(52) U.S. Cl. CPC G06Q 50/205; G06K 7/10366

(57) ABSTRACT

The present invention provides a method and a system for receiving school data from one school administration device; storing the school data to a remote server; receiving attendance data from one teacher device, dedicated room data from one dedicated hardware device, and unique identification data from one input device; processing the school data, the attendance data, the dedicated room data, and the unique identification data; generating a record of movement; analyzing the school data, the attendance data, the dedicated room data, the unique identification data, and the record of movement to generate an activity identifier; storing the activity identifier and the record of movement to the remote server; generating a visualization; generating a notification; transmitting the notification to the one school administration device, the one teacher device, and one guardian device; and storing the notification.

### FIELD OF THE INVENTION

The present invention relates generally to data processing. More specifically, the present invention is methods and systems for facilitating managing student attendance and movement of individuals throughout a school facility.

### BACKGROUND OF THE INVENTION

Schools struggle with attendance in a multitude of ways. Teachers complying with attendance, the accuracy of attendance during emergencies, and the general lack of knowledge as to the whereabouts of any given student, visitor, or staff member, makes administrating a school more about the physical status of a student rather than the academic status. Add to this the difficulties posed by COVID, and the problem of monitoring the movement of thousands of masked individuals becomes impossible. Therefore, there is a need for improved methods and systems for facilitating managing student attendance and movement of individuals throughout a school facility that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a system for facilitating managing student attendance and movement of individuals throughout a school facility is disclosed. Accordingly, the system may include a communication device configured for receiving school data from at least one school administration device associated with at least one school administrator. Further, the communication device may be configured for receiving attendance data from at least one teacher device, dedicated room data from at least one dedicated hardware device, and unique identification data from at least one input device. Further, the communication device may be configured for transmitting a notification to the at least one school administration device, the at least one teacher device, and at least one guardian device. Further, the system may include a processing device configured for processing the school data, the attendance data, the dedicated room data, and the unique identification data. Further, the processing device may be configured for generating the record of movement based on the processing. Further, the processing device may be configured for analyzing the school data, the attendance data, the dedicated room data, the unique identification data, and the record of movement to generate the activity identifier. Further, the processing device may be configured for generating the visualization based on the activity identifier and the record of movement. Further, the processing device may be configured for generating the notification based on the analyzing and the processing. Further, the system may include a storage device configured for storing the school data to a remote server. Further, the storage device may be configured for storing the notification. Further, the storage device may be configured for storing the activity identifier and the record of movement to the remote server.

According to some aspects, a method for facilitating managing student attendance and movement of individuals throughout a school facility is disclosed. Accordingly, the method may include receiving, using a communication device, school data from at least one school administration device associated with at least one school administrator. Further, the method may include storing, using a storage device, the school data to a remote server. Further, the method may include receiving, using the communication device, attendance data from at least one teacher device, dedicated room data from at least one dedicated hardware device, and unique identification data from at least one input device. Further, the method may include processing, using a processing device, the school data, the attendance data, the dedicated room data, and the unique identification data. Further, the method may include generating, using a processing device, a record of movement based on the processing. Further, the method may include analyzing, using the processing device, the school data, the attendance data, the dedicated room data, the unique identification data, and the record of movement to generate an activity identifier. Further, the method may include storing, using the storage device, the activity identifier and the record of movement to the remote server. Further, the method may include generating, using the processing device, a visualization based on the activity identifier and the record of movement. Further, the method may include generating, using the processing device, a notification based on the analyzing and the processing. Further, the method may include transmitting, using the communication device, the notification to the at least one school administration device, the at least one teacher device, and at least one guardian device. Further, the method may include storing, using the storage device, the notification.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a schematic of a system for facilitating managing student attendance and movement of individuals throughout a school facility, in accordance with some embodiments.

FIG. 3 is a flow diagram of a method for facilitating managing student attendance and movement of individuals throughout a school facility, in accordance with some embodiments.

FIG. 4 is a flowchart of a method for facilitating uploading information related to rooms, floor plans, users, schedules, and academic data of a school, in accordance with some embodiments.

FIG. 5 is a flowchart of a method illustrating the configuration of desktop, mobile, and hardware devices to be associated with rooms, in accordance with some embodiments.

FIG. 6 is a flowchart of a method for collecting data associated with the user and transmitting to the remote server, in accordance with some embodiments.

FIG. 7 is a flowchart of a method for associating the unique identification code, timestamp, and room information transmitted to create a record of movement, and determine entry or exit from a given room, in accordance with some embodiments.

FIG. 8 is a flowchart of a method for facilitating association of student movement data with the academic schedule data to determine whether the student activity processed is an attendance-related action, in accordance with some embodiments.

FIG. 9 is a flowchart of a method for facilitating transferring of attendance data to attendance records stored in one or more remote servers for use with student transcripts, reporting, and other academic functions, in accordance with some embodiments.

FIG. 10 is a flowchart of a method for facilitating the processing of the records of movement across rooms and floor plans to translate into a visual representation of movement across rooms and floor plans, in accordance with some embodiments.

FIG. 11 is a flowchart of a method for facilitating notifying designated users when user movement indicates an action that requires attention, in accordance with some embodiments.

FIG. 12 is a flowchart of a method for facilitating transferring of data from the remote server back to the devices in step B to indicate a successful match, in accordance with some embodiments.

FIG. 13 is a flow chart of a method for facilitating managing student attendance and movement of individuals throughout a school facility, in accordance with some embodiments.

FIG. 14 is a block diagram of a system for facilitating managing student attendance and movement of individuals throughout a school facility, in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating managing student attendance and movement of individuals throughout a school facility, embodiments of the present disclosure are not limited to use only in this context.

### Overview

The present disclosure describes methods and systems for facilitating managing student attendance and movement of individuals throughout a school facility. Further, the disclosed system may be associated with student attendance and movement throughout a school facility. Further, the disclosed system may be associated with a software platform that manages the arrival and departure of students, as well as faculty, staff, and visitors, from classrooms, and utilizes various hardware and software scanning as means of identifying student arrival and departure from classrooms, and then associating this data with attendance records.

Further, a system platform of the disclosed system may be executed on a remote server as the system platform includes a plurality of student supervision features, a plurality of staff profiles, a plurality of teacher profiles, a plurality of parent profiles, a plurality of visitor profiles, a plurality of academic schedules and attendance data, and a plurality of notification preferences and capabilities that are stored within the remote server, or associated with another system with which the remote server communicates.

To engage with the system platform, students, faculty, staff, parents, and visitors can access a website or mobile application which communicates with the remote server through the utilization of an application program interface (API) on a remote mobile device, such as a smartphone, tablet, smartwatch, etc. Users may also engage with the system platform by interacting with mobile devices or dedicated hardware, such as barcode readers or radio frequency identification (RFID) readers, which are positioned in rooms throughout the academic facility, and these devices and dedicated hardware communicate with the remote server through the utilization of an API. In addition, users can engage with the system platform by accessing an Angular application, which runs on a remote server.

Further, the disclosed system may be associated with a campus management kiosk is a mode within a visitor management app associated with the disclosed system that allows the app to be associated with specific rooms at a school, and to process check-in and check-out requests to that room.

Further, the check-in and check-out actions are translated back to a Campus Management Dashboard, a screen in an angular website associated with the disclosed system. Further, all user types (students, parents, faculty, staff, visitors) may scan in and scan out of the kiosk with these methods. These interactions create logs of movement which are valuable to administrators for both day-to-day and emergency use.

More than one kiosk may be associated with the same room (think of a large concert hall with multiple entrances and exits).

For instance, Mrs. Jones is a 9^{th} Grade English Teacher. Typically, Mrs. Jones has had difficulty remembering to take attendance until after the bell has rung, and when she has to teach 3 back-to-back sections of the course each with 19 students in attendance, remembering who was late (or even present) can be laborious. Additionally, when students are late or not present, it falls on Mrs. Jones to report that to the dean, who keeps track of these for disciplinary purposes. It may not seem like much, but especially at the start of the year, the process of learning hundreds of new faces (now masked because of COVID) makes attendance a time-consuming task, and Mrs. Jones is already pressed for teaching time because of the schedule.

With the Campus Management Kiosk, teachers like Mrs. Jones only have to worry about watching a list of student names on their mobile, laptop, or desktop devices auto-populate attendance. Students signing will be moved to “present” on her attendance screen, and all she has to do is confirm the correct number of students who signed in are there, and the ones who are missing aren't. This speeds up the process of taking attendance, and if she ever “forgets” to do so, there will be a log of sign-ins to refer back to that count as attendance for her sections of English.

In another instance, Mrs. Collins, is an administrative assistant for Upper School. Whenever a teacher, admin, or parent approaches Mrs. Collins' desk to ask “Where's Johnny,” it feels like the ground is falling out underneath her. Mrs. Collins pulls up Johnny's schedule, only to be told “I'm pretty sure he was in math class, but he didn't show up to the band.” She has no idea whether Johnny went to the nurse, was pulled into an administrator's office, is snacking in the cafeteria, or is even on campus. This kicks off a process of Mrs. Collins leaving her desk to roam the hallways, tracking down leads, paging teachers over the intercom, and generally disrupting the entire flow of the school until the request is answered. On easy days, this process can take 5-10 minutes, but with Johnny, the story's always a bit more complicated. He says he was meeting with his science teacher in their classroom, but that teacher is currently instructing another section so Mrs. Collin can't verify until that teacher is free. Toward the end of the day, Mrs. Collins finally catches the science teacher who says Johnny wasn't with them; now Mrs. Collins must write a message to the head of the division with the details, to be followed up on tomorrow. One simple request, “Where's Johnny?”, has turned into a multi-day communications relay. Further, the disclosed system may allow Mrs. Collins to now instantly search for Johnny's last known whereabouts with accuracy previously unattainable. In addition, Mrs. Collins can see where Johnny is supposed to be, and a series of scan ins and outs tell the story of where he's been throughout the day. As it turns out, Johnny went to the nurse's office and missed band—what could have been a time-consuming and contentious interaction is entirely avoided.

In an instance, Mr. Anderson, is Johnny's father. Mr. Anderson is told yet again that his son was not present for all his classes today and will be required to serve a Friday afternoon detention; however, getting the straight answer from the school takes a suspiciously long time to verify. Mr. Anderson starts to wonder if the school has their act together, and maybe Johnny was present for all classes. He is getting the feeling the school does not have a handle on students and Mr. Anderson prompts administrators with questions about their safety practices. “How do you people even know my kid was here at all today?” (Yes, I have seen this situation unfold—names have been changed). Further, because Mr. Anderson's school uses the Campus Management, and the school policy requires all students to sign into classrooms when they arrive, he knows exactly when and where Johnny was and should have been. This gives him and the administration the same set of facts to talk through and creates a more collaborative conversation around Johnny's academic development.

For instance, Johnny is tired of relying on adults to remember where he was, and when he was there. They all seem a bit too preoccupied to be trusted with that task, and he's constantly questioned about where he was, and where he's supposed to be, throughout the day. Why can't he just have his schedule on his phone, follow the schedule, check in to class like he does everything else in his personal life (i.e. digitally), and be done with it?

Johnny likes having a school ID and far prefers to sign into and out of rooms than constantly be nagged about his whereabouts and worrying about where he's supposed to be on special schedule days. He can just check his phone and it's all there! He's hoping one day to turn this digital ID with his QuickPIN (maybe called a SchoolPass) into a card he can use to buy things in the school store and at bake sales!
1. Operating System & Device Requirements associated with the disclosed system may be:
   a. iOS 14+
   b. Android 10+
   c. iPad 8^{th} Gen+
   d. Android Tablets
2. Home screen display
   a. Home screen must display the logo at top of the screen (see Reference material 1—mockup, item 1)
      i. Default logo will be SchoolPass, though school must be able to replace with their own logo
      ii. Schools can select from preset color schemes
      iii. Press and hold on the logo to access kiosk settings
         1. Kiosk settings must be protected by a school-defined PIN number
         2. Settings will allow a school to pair the device with specific room defined on their Campus Management Web Dashboard
         3. Settings will allow control over scan behavior and methods
         4. Settings will allow pairing with an RFID reader
         5. Settings will allow a school to show/hide emergency button on a specific kiosk
6. Settings will allow the school to configure which camera (front/rear) is used for scanning
   b. Emergency Functionality
      i. The home screen must display the “Emergency” button (Ref. 1, item 2) if the school has Emergency Module enabled and the setting is enabled in kiosk-specific settings
      ii. Press the emergency button to open modal to report an emergency
      iii. A modal will have the same options as in the staff app
      iv. When the emergency is submitted, the room number, level, and building information will be included in data sent to Emergency Module
      v. After triggering an emergency, the display of the kiosk must be altered to indicate that it is in an emergency mode
      vi. Users may end the emergency on the kiosk only after entering a PIN specified by the school
   c. The home screen must display the name of room, level, and building information as selected in kiosk-specific settings (Ref. 1, item 3 & 4)
      i. Multiple kiosks may be associated with one room
      ii. Rooms, and their corresponding level and building associations, are defined in the Campus Management dashboard in Angular web
   d. The home screen should display current date, rotating day, period, section (i.e. class), start and end time of section, and teacher that are occurring in this room when associated with a section on the school's per period or daily attendance schedule (Ref. 1, item 5)
      i. This information is dependent on schools having per period or day level attendance integration with, or all attendance occurring within, SchoolPass Attendance module
      ii. This information is not displayed if the room associated with the kiosk is not linked to any section on the academic schedule
         1. i.e. The Nurse's office does not show this information because it does not have any section associated with it.
      iii. This information will be displayed in any room that is associated with a section on the academic schedule
         1. i.e. The 9^{th} grade English classroom 101 will show the current date, the rotating day of the schedule, the current period within that rotating day schedule, the name of the section, start and end time of that section, and the current teacher for that section in Room 101
   e. The home screen could display the name of the next class in this room when associated with a section on the school's per period or daily attendance schedule (Ref. 1, item 6)
      i. If there are no sections occurring after the current one, display nothing
      ii. This is not required for an MVP
3. Methods of Scanning
   a. The home screen must allow for touchless sign in and sign out (Ref 1, item 7)
      i. Scanning QR code with mobile device brings the user to Angular webpage for sign in and out with PIN (same as touchless VM)
      ii. QR code must refresh frequently (i.e. every 30 seconds) to avoid student misuse
   b. The home screen must allow for camera access that processes QR code and Barcode scan in and out (Ref 1, item 8)
      i. Barcodes and QR codes, either printed or on mobile devices, will be scanned using a device camera (utilizing MicroBlink SDK in VM app currently)
      ii. Scans must be done quickly, so the device needs to allow for a “continuous scan” mode
         1. After selecting scan in and out via QR code and Barcode, the camera stays open to allow for multiple users to scan in rapid succession
         2. Users must be able to close the continuous scan mode and return to the home screen by pressing a “close” icon on the continuous scan mode
      iii. Device must visually alert scan in/out complete
         1. Kiosk screen must display a user has successfully scanned by showing the user's name on screen and whether they have scanned in or out of a room
         2. The device may be configured to make a chime noise when a user scans successfully
   c. The home screen must allow for manual entry of user QuickPIN for sign in and out (Ref 1, item 9)
      i. Choosing this option opens a keyboard for users to type a PIN
      ii. Entering a PIN successfully displays the user name and whether they have scanned in or out of the room
   d. The kiosk must have the capability to pair with an RFID reader
      i. Kiosk settings must allow for Bluetooth pairing with RFID scanner (as is possible in the current VM application)
4. Scan In
   a. When a user first scans at a kiosk using one of the methods mentioned in 3: Methods of Scanning, this is recorded as a scan-in.
      i. The scan in action creates a record that a particular user arrived at a particular room (associated with the kiosk) at a particular time.
      ii. A scan-in can but does not have to, be associated with attendance.
         1. For example, the nurse's office will allow users to scan in, but these visits do not have schedules associated with them when the nurse's office isn't tied to a section that takes attendance.
         2. This scan-in allows the school to keep track of users whether or not their movement is associated with a record in the attendance system.
   b. When a scan in is successful, the kiosk must display the user's name, and an obvious message that they have scanned into the particular room associated with the kiosk on the screen upon scan in.
   c. If a user scans into one room, and forgets to scan out, then scans into a second room, the system needs to mark the time that they scanned into the second room as their “automatic scan out time” from the first room.
      i. A user can't be scanned into two physical rooms at one time, so as soon as a user scans into one room, scanning into any other room marks an end time for their presence in the first one.
5. Scan Out
   a. If a user scans in at a kiosk, then scans their code on a kiosk a second time, before scanning in at any other rooms, the system will record this as a “scan out.”
      i. A user can be scanned into only one room at a time, so the second time a user has scanned at the same room means they are exiting the same room they are currently in.
      ii. There are several reasons why it is important to have scan-out functionality.
         1. As an example, in the middle of a science class, a student says they need to use the restroom; they scan out of the room so the system keeps a log that they left the room during the period. This does not affect their attendance record, but it leaves a record of their leaving
         2. Another reason manual scan outs can be helpful is for the administrator to visualize which rooms are occupied, and which rooms are not, on the campus management dashboard. Many times, there are “multi-purpose” rooms or offices that have unpredictable schedules, so if users wish to utilize these rooms at the moment, they can have a better idea of which rooms have no one present.
   b. As with scan in, scan out must display a clear message to the user that they have scanned out of a particular room.
6. Attendance Automation
   a. When students scan into a kiosk, which is always associated with a room, if a school has configured their attendance records with room data, this scan can trigger an action in the attendance system.
      i. Students scanning into rooms in this configuration can effectively “automate” taking of attendance for the section of a class that is designated to occur in that room at that start and end time.
   b. Students who scan in before the “late” cutoff for each period will be marked as present, and the teacher's attendance screen will reflect this.
   c. A student who signs in after the “late” cutoff for each period will be marked as late, also reflected on attendance.
   d. Students who do not sign in, yet are registered to be in the section of a class that is supposed to meet in that room at that time, will be marked as “not present” on the teacher's attendance screen, which will be the new default attendance type in per period attendance.
   e. A teacher can still override any of these in their attendance screen and serves as a check on the integrity of the scans that students create in that classroom.
   f. Students who need to leave class in the middle of a scheduled period can “scan out” so that there is a log of their leaving the room, which helps the school keep track of those students.
      i. When a student scans back into the room mid-class, it does not override their original attendance status (late, on time, etc.)
   g. At the end of the class, there is no attendance penalty for students forgetting to sign out of the room
      i. Once students sign into the next room, they are marked as having left the first room

Further, the disclosed system may be associated with a Campus Management Dashboard (CMD) that may be a module that can be enabled within our existing Angular website.

The Campus Management Kiosks are associated with rooms designated in CMD. These check-in and check-out actions occurring on the kiosks are translated back to CMD, which visualizes the movement of that user across campus. Further, schools may upload their floor plans to the CMD, then designate rooms on those floor plans. This creates a list of rooms that can be associated with CM Kiosks. CMD must allow for searching users, and movement records to be exported from the system for additional review. CMD may allow for notifications to be sent to the individual being searched on this page. CMD may provide an export indicating others with who this user was in the same room during the day. CMD may provide a visual representation of where an emergency alert has been triggered. CM dashboard data maybe be associated with school attendance data; this in combination with the CM kiosks creates an attendance automation solution. School administrators can visualize a student's attendance status, and see whether they were late, on time, or not present to classes on their schedule.

In an instance, (copied from PRD SP6-001 Section III) Mrs. Collins is the administrative assistant for an upper school. Whenever a teacher, admin, or parent approaches Mrs. Collins' desk to ask “Where's Johnny,” it feels like the ground is falling out underneath her. Mrs. Collins pulls up Johnny's schedule, only to be told “I'm pretty sure he was in math class, but he didn't show up to the band.” She has no idea whether Johnny went to the nurse, was pulled into an administrator's office, is snacking in the cafeteria, or is even on campus. This kicks off a process of Mrs. Collins leaving her desk to roam the hallways, tracking down leads, paging teachers over the intercom, and generally disrupting the entire flow of the school until the request is answered. On easy days, this process can take 5-10 minutes, but with Johnny, the story's always a bit more complicated. He says he was meeting with his science teacher in their classroom, but that teacher is currently instructing another section so Mrs. Collin can't verify until that teacher is free. Toward the end of the day, Mrs. Collins finally catches the science teacher who says Johnny wasn't with them; now Mrs. Collins must write a message to the head of the division with the details, to be followed up on tomorrow. One simple request, “Where's Johnny?”, has turned into a multi-day communications relay.

Further, the disclosed system may allow Mrs. Collins to now instantly search for Johnny's last known whereabouts with accuracy previously unattainable. In addition, Mrs. Collins can see where Johnny is supposed to be, and a series of scan ins and outs that tell the story of where he's been throughout the day. As it turns out, Johnny went to the nurse's office and missed band—what could have been a time-consuming and contentious interaction is entirely avoided.

For instance, Mr. Reynolds is a Director of Security: Whenever a student can't be found for even a moment, Mr. Reynolds loses a little piece of his mind. He is responsible for instilling security principles across the school, yet everywhere he looks there's some violation of protocols he's been trying for years to instill. The school finally allowed him to purchase SchoolPass visitor management kiosks, but he knows with a little adjusting they can do so much more. Managing safety for over a thousand students, all of their parents, visitors, and staff across two campuses is overwhelming Mr. Reynolds' team's ability to accurately understand what is happening at any moment on any given day.

Further, Mr. Reynolds' dream is to open his phone or his laptop and know exactly what everyone is doing across these two campuses every day so he can feel a little more control, and that's exactly the need CMD fulfills. He may access the disclosed system and finally has a way to see exactly what is going on with a specific student, in a particular emergency, or during a drill.
7. Operating System & Device Requirements associated with the disclosed system may be:
   a. Chrome
   b. Firefox
   c. Edge
   d. Safari
8. Dashboard Overview (Reference 1)
   a. The Campus Management Dashboard (CMD) must display the following items
      i. Campus Management Submenu
         1. Tabs to navigate from the dashboard to room configuration and floor plan uploads/adjustments (Ref. 1, item 1)
      ii. Campus Management Dashboard Live Overview of Entire School
         1. The ability to see the entire campus, floor plan by floor plan, and see a live log of activity with scan in and out records on a single view
         a. If the Campus Management Dashboard viewer (person using CMD, referenced in this document as CMD viewer) has not selected any filters, display a live running list of current scan ins and outs at different kiosks across campus
         b. Selecting a different floor plan from the Floor Plan View Tabs (2.a.viii) will show live updates to activity on that specific floor plan view
      iii. Filter Options (Ref 1, item 5)
         1. A set of filter options that can be used to filter the live overview of campus, as well as filter search results, based on the following criteria
         a. Site of user allows for filtering based on the site that student belongs
         b. Grade allows for filtering students based on grade
         c. Class (or “section” in per period attendance terminology) allows for filtering based on users who are enrolled in a particular section of a class
         d. Change Type filters on users who are registered with a particular change type (i.e. Late Arrival, Early Dismissal)
         e. From Date filters the earliest date of the activity that the CMD viewer is displaying
         f. To Date filters the latest date of the activity that the CMD viewer is displaying
      iv. Search (Ref 1, item 2)
         1. Search functionality to find a specific user and display their movement
         a. Matched users are displayed in search dropdown as CMD viewer enters characters for search
         i. Matches show profile picture, first and last name, user type, External ID, and grade
         b. CMD viewer may search based on several different criteria currently available in the user search on the Angular site
         i. Last Name
         ii. First Name
         iii. QuickPIN
         iv. External ID
         c. Search results are filtered by filter settings (2.a.iii Filter Options)
         2. When the search is complete and the CMD viewer selects a record, a placard with the found user's information, including the following fields (Ref. 1, item 4)
         a. First and last name
         b. Wellness status (if enabled at this school)
         c. Current date (or date range of filters—Ref. 1, item 5)
         d. Arrival for the current date (or date range of filters)
         e. Dismissal for the current date (or date range of filters)
         f. User's External ID (not displayed in Ref. 1)
         3. Clicking the user's name on the placard will bring the viewer to their User account (if the current CMD viewer has permissions to the Users section of SchoolPass)
      v. See All Contacts (Ref 1, item 3)
         1. A function that returns a list of others who have been in the same room as this user at the same filtered time and date range
         a. The date range is determined by filters in 2.a.iii. Filter Options
         2. A list of returned records can be exported to Excel or CSV
         a. First name
         b. Last name
         c. User Type
         d. Grade
         e. Site
         f. Email
         g. Phone
         h. External ID
         i. Room signed into
         j. Time signed in
         3. CMD viewer should be able to send a notification to records in this found set utilizing the Messenger module
         a. This is dependent on the school having the Messenger module enabled
      vi. Send Notification (Ref 1, item 3)
         1. A function that allows the CMD viewer to send a notification to the user returned in the search
         a. This is dependent on the school having the Messenger module enabled
      vii. Floor Plan View Tabs (Ref. 1, item 6)
         1. Tabs that allow the CMD viewer to see the floor plans that contain rooms a found user has visited during the selected date range
         a. When a CMD viewer searches for a particular user's movement activity, the floor plan tabs narrow down only to those with activity on that particular date range
         b. Selecting a movement record from the bottom of the page (Ref 1, item 10) will change the tab to the floor plan that matches the room on that selected record
      viii. Movement Visualization (Ref 1, item 7)
         1. Icons should appear on the floor plan with color and numerical indicators to show in what order the user has visited rooms (Ref 1, item 7)
         a. Numbers indicate the order in which the user visited rooms
         b. The color indicates whether the visit was on time, late-unexcused, late-excused, or if the user was not present when they were expected to sign in to a particular room
         i. This depends on the school utilizing per period attendance, which is detailed in a separate PRD document
         c. A user's last known location should be easily distinguished from the other dots
         d. If a CMD viewer hovers over one of the dots indicating a visit, if this school has integrated per period attendance, this should show the following information about that scan in (Ref 1, item 8)
         i. The name of the teacher for the section that met in that room at that time
         ii. The name of the section
         iii. The status of the check-in (i.e. late, on time)
         iv. The color of that indicator should also reflect the status
         v. The time and date of that check-in
         2. Lines should connect the points in sequence so the viewer can get a highlighted view of where the found user has traveled
         3. As the user moves between floors and buildings, points in their movement history should be displayed on those tabs as indicated in “Floor Plan View Tabs 2.viii”
      ix. Movement Records
         1. CMD viewer should see records for all room visit activity for their searched or filtered users (Ref 1, item 10)
         a. If the CMD viewer has searched for an individual user, the records that appear should narrow down to that user in the date range in the filters area
         b. Information that should appear in the movement records:
         i. The order should indicate the order in which the user visited that room over that particular period
         ii. The location should indicate the name of the room a user visited—the room is associated with each kiosk, the room name is designated in the Rooms tab (Ref. 1, item 1)
         iii. The campus should display the name of the campus associated with this room, floor plan, and site
         iv. The site should display the site associated with the floor plan and room
         v. A level should display the level associated with the floor plan and room
         vi. Time in should display the time the user scanned into that particular room
         vii. Time out should display the time the user scanned out of that particular room
         1. Users are not required to sign out of each room, as mentioned in PRD SP6-001
         2. Once a user signs into a second room, if they haven't signed out of the first room, the Time Out for the first room should be populated with the same time they sign in to the second room, and some kind of indication that this sign out was automatic rather than manually initiated on the kiosk
         viii. Status should display the corresponding status of the student's attendance at that given room check-in
         1. This must only display a value when the room check-in is tied to a per period attendance schedule
         2. If the user is not a student, this should not display a value
         3. If the user is a student and they sign into a class on time, this should display “On Time” in green
         4. If the student signs into a class late, and the attendance administrator or the section teacher indicates the lateness as “excused”, then the status should display “Late—Excused” in blue
         5. If the student signs into a class late, and neither the attendance administrator nor the section teacher marks the lateness as “excused”, this is marked as “Late—Unexcused” in orange
         6. If the student does not sign into a room where they are enrolled in a class, and the teacher marks the student as “not present” for that period, the status on this record should display “Not Present” in red
         2. CMD viewer should be able to display several additional columns of data (Ref 1, item 11)
         a. CMD viewer should be able to display a column with the name of the section that met in that room at that time
         b. CMD viewer should be able to display a column with the teacher's name for the section of the class that met in that room at that time
      x. Export
         1. CMD viewer must have the ability to export all records currently filtered/viewed as Excel or CSV (Ref. 1, item 9)
         a. Records that are currently filtered or searched that display in the list of movement records should export to Excel with the same columns that are visible on screen, as well as adding in any additional hidden columns
      xi. Movement Overview Pie Chart
         1. An area for analytics on movement displays as a pie chart (Ref. 1, item 12)
         a. The pie chart should break down the number of occurrences of on-time, late—unexcused, late—excused, and not present movement records in the filtered or searched set
   b. Rooms
      i. CMD Admin user (Defined in 4. User Permissions) needs a screen to designate rooms on the uploaded floor plan images
         1. By creating this on top of a specific floor plan, the room can be linked with a specific level of a building, site, campus, and other details associated with the floor plan itself.
      ii. CMD Admin can see the device name of the specific iPad or Android tablet that is linked with that room
         1. Users may also see when the device was last active on this tab
         2. More than one device can be associated with a room
      iii. CMD Admin can view analytics about how often rooms are utilized throughout the day
         1. The average number of sign-ins per hour
         2. Peak use time based on day of week
         3. Peak use time based on rotating day of schedule
      iv. Rooms that are created in Campus Management can be associated with rooms identified on section records for per period attendance
         1. CMD Admin must have a way to confirm that the room they've created in CMD is properly associated with the sections in their attendance configuration
      v. Rooms can be imported from the SIS
         1. Blackbaud, for example, provides schools a way to designate rooms, and place them in buildings
   c. Floor Plans
      i. CMD Admin can upload image files of their school's floor plans and associate those with the following information
         1. Campus
         2. Site
         3. Building
      ii. Uploaded floor plans can be “drawn on” in the web browser to designate areas where rooms can be assigned
9. Emergency Management
   a. During an emergency, the dashboard must display unique functionality
      i. The dashboard must allow for CMD viewer to quickly identify which room or site from which an emergency was triggered
         1. If the emergency was triggered via a CM kiosk, the room should highlight in red and be presented at the forefront of the dashboard
         2. Rooms should change to indicate the number of students, faculty, and staff who have checked in as “safe” in those areas
         3. Anyone who has been marked as “needing medical attention” should appear on the map and be highlighted with the emergency notes recorded via the app in view
10. User Permissions
   a. Setting User Permissions
      i. As a SuperUser or SuperAdmin, need access to a tab of Campus Management that allows for designating specific staff members to be CMD Admin or CMD Viewer level access
         1. Similar to how the system currently functions for Wellness
   b. CMD Admin
      i. CMD Admin is a user-level that allows full access to all aforementioned tabs and settings within the CMD module
      ii. CMD Admins may designate other staff members to become CMD Admins
      iii. When a CMD Admin is designated or removed, generate an email to internal security staff
   c. CMD Viewer
      i. CMD Viewer is a user-level that allows view-only access to the Dashboard page only, and the following settings
         1. No access to creating floor plans
         2. No access to designating rooms
         3. No ability to export data
         4. No ability to utilize “See All Contacts”
      ii. When a CMD Viewer is designated or removed, generate an email to internal security staff

Rather than taking attendance one time at the start of the school day, many middle and high schools have schedule configurations that require multiple teachers to take attendance for their students throughout the day, otherwise known as “per period attendance.” For example, a student who is present for their first class of the day might be marked as “not present” during their second class. In our current configuration, this would mark the student absent for the entire day, erasing all their dismissal information. Further, the existing system also does not accommodate students attending different classes with different teachers throughout the day, but rather groups students only in terms of arrival and dismissal locations. To further complicate matters, the sections of courses a student is enrolled in and the times they attend those sections rotate from day to day, and that rotation can be, and often is, completely arbitrary.

Further, the disclosed system may be associated with a Per period attendance configuration for taking attendance that allows teachers to take attendance for each period of the school day. Schools must be able to define the courses, sections, time blocks, and student registrations within their own Student Information System, or SIS, and SchoolPass must be able to pull that information in to build the daily per period attendance rosters. Teachers must be able to take attendance for multiple sections a day, and those sections should follow the same start and end times defined in their SIS platform. When teachers take attendance in a per period attendance configuration, they should have the ability to mark a student as “not present” in a way that indicates they are not in the class and does not have the same effect as marking a student as “absent” in the existing system. Schools must be able to define rotations of sections and varying start and end times within their SIS systems and tie those rotations to specific dates, and SchoolPass (an exemplary embodiment of the disclosed system herein) must pull the correct rotation and start/end times on the correct date. Schools must be able to change the schedule mid-day due to emergency or weather conditions so that the remaining classes on the schedule do not have to take attendance. Further, the attendance data must be transferred from SchoolPass into the SIS throughout the day to keep both systems in sync. Further, the schools must be able to automate notifications to go to.

For instance, Mrs. Smith is a teacher of 9th grade English, and she has 4 back-to-back sections of the course on Monday morning from 8-noon. It's a struggle just to focus on instruction, let alone who was present. Attendance needs to be as easy as humanly possible for Mrs. Smith to get back to focusing on educating the students in her class. Using the SchoolPass web or mobile app, Mrs. Smith can quickly and easily take attendance for the appropriate section of her class. Rosters are updated with absence, late arrival, and early dismissal information, and paired with Campus Management, she can sit back and watch the attendance data populate for her. If a student needs to leave mid-class, they can sign out and do so without the teacher being forced to “keep a timer” and hunt them down later if they skip the remainder.

In an instance, Mr. Jones is an administrator trying to identify who is present today and not in third-period class. Some students have a study hall during this time, but there are always a few who seem to slip by his radar. He scours the hallway looking for stragglers, and can't always count on his teachers to complete attendance in a timely fashion. Per-period attendance in SchoolPass gives Mr. Jones one simple view of all the students who have not yet been checked into a class, as well as factoring in their virtual, absence, late arrival, and early dismissal information. Mr. Jones can also easily tell where a student has last been seen when integrated with campus management, so he has at least some idea of which halls to be monitoring for students.
11. Operating system and device requirements.
12. Student Information System Requirements
   a. Blackbaud integration
   b. Veracross integration
   c. Powerschool integration
   d. Senior Systems integration
   e. Other SIS integrations (using flat files for data exchange)
13. Per Period Attendance Framework—Definitions & Overview
   a. Schedule
      i. Defines a per period attendance schedule at the highest level
      ii. Schedules contain custom-defined “days” occurring on rotations and ties those days to a calendar date
      iii. Has start and end dates tied to the calendar
      iv. Typically, is used by one division or “site” but could be different schedules that vary by grade level
   b. Day
      i. A set of time blocks lined up start to finish comprise a per period attendance “school day”
      ii. Days can have custom names (i.e. “Day C” or “Day 1 Schedule”)
      iii. Days are associated with calendar dates via the schedule
   c. Rotation
      i. Days have a preset rotation
         1. Day 1, then Day 2, then Day 3, and finally back to Day 1
      ii. Not all Days are used in a rotation
         1. “Assembly Day” may be a defined day that is only associated on the calendar via the schedule
      iii. Rotations aren't locked
         1. Day 1 can be followed by Day 2, then back to Day 1 again
   d. Course
      i. A course is the highest-level unit in an academic subject
      ii. Section records are created underneath courses
   e. Section
      i. Linked to Course
      ii. Linked to Teacher
      iii. Linked to Room
      iv. Linked to Block
      v. Sections are created from courses in the SIS
      vi. Each section indicates a unique record that ties a teacher with a set of students
      vii. Each section is associated with a time block
      viii. Each section is associated with a room
   f. Room
      i. Linked with Sections
      ii. Rooms are associated with sections to determine where that section occurs
      iii. Campus Management will rely on room information-carrying into the SchoolPass system to tie scan in/out of particular students with attendance information
   g. Time block (a.k.a. Period, or Block)
      i. Linked to Schedule
      ii. Linked to Rotation
      iii. Defines the start time and end time of a given period
      iv. Time blocks can have custom names (i.e. “D Block” vs. “Block 3”)
   h. Student Registration (or Student Enrollment in Sections)
      i. Linked to Section
      ii. Student registrations are records that tie a student to a given section
      iii. Students will have one registration per section they are enrolled in
      iv. Student registrations are used by the SIS to determine rosters for sections, and therefore integral to attendance
      v. https://developer.sky.blackbaud.com/docs/services/school/operatio ns/V1AcademicsEnrollmentsByUser_idGet
14. Admin Attendance
   a. Dashboard
      i. Navigation
         1. Admins must be able to see all sections occurring during the current time block of the current day
         2. Admins must be able to toggle between time blocks occurring on a given day
         3. Admins should be able to see an overview of all statistics for the current time block as well as the current day, including
         a. Number of absent students
         b. Number of late arrivals
         c. Number of early dismissals
         d. Number of students “not present” in the current period
         e. Number of students late to class in the current period
         f. Number of students signed out of the room for a class currently in session
         4. Clicking into a section listed on-screen should bring admin to teacher-level view
      ii. Send Reminder
      iii. Export
15. Teacher Attendance
   a. Section Rosters
   b. Attendance Functions
      i. Start Attendance
         1. Present
         2. Not Present
         3. Absent
         4. Late Arrival
         5. Early Dismissal
         6. Virtual
         7. Notes
      ii. Complete Attendance
16. Notification Framework
17. Reporting Framework
   a. Exporting to CSV and Excel
18. Integration with Emergency Management
19. Integration with Campus Management
20. Integration with SchoolPass Mobile App
   a. Staff
   b. Teacher
   c. Parent
   d. Student
21. Virtual Attendance

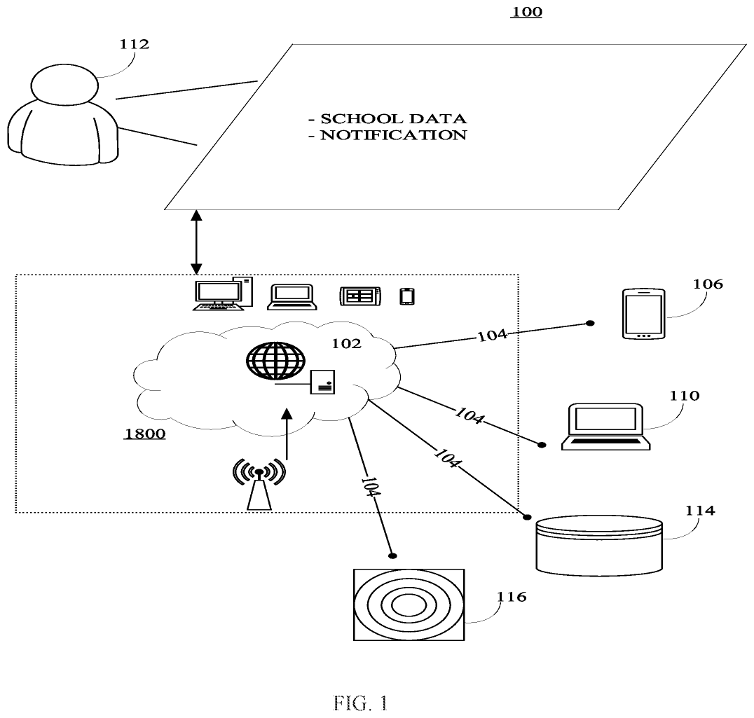

FIG. 1 is an illustration of an online platform 100 consistent with various embodiments of the present disclosure. By way of non-limiting example, the online platform 100 for facilitating managing student attendance and movement of individuals throughout a school facility may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, service providers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 1800.

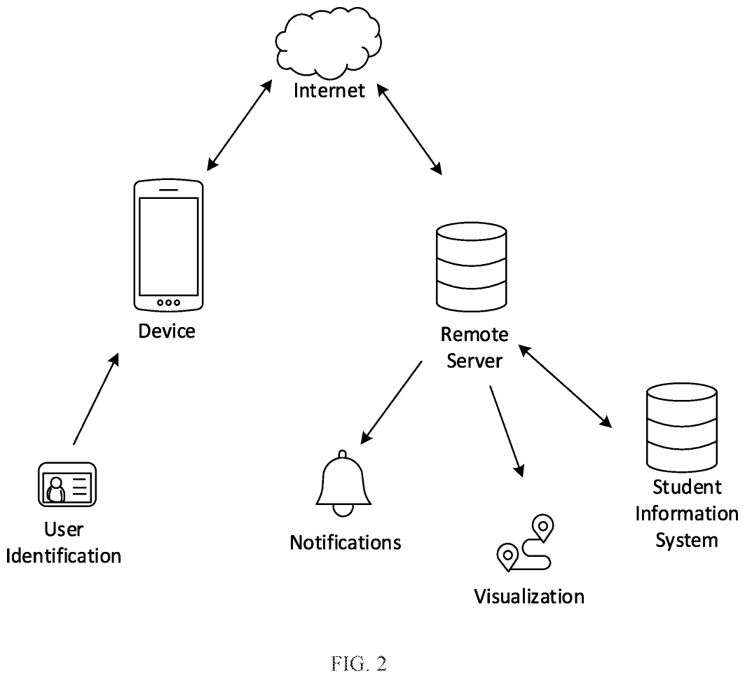

FIG. 2 is a schematic of a system for facilitating managing student attendance and movement of individuals throughout a school facility, in accordance with some embodiments.

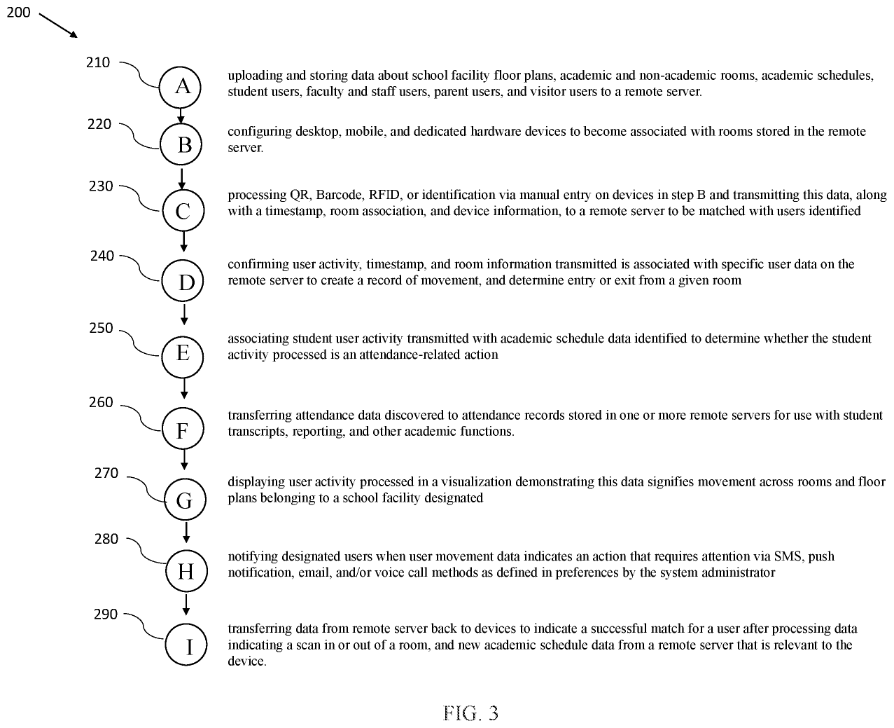

FIG. 3 is a flow diagram of a method for facilitating managing student attendance and movement of individuals throughout a school facility 200, in accordance with some embodiments. The method 200 of the present invention may include steps of A 210, B 220, C 230, D 240, E 250, F 260, G 270, H 280, I 290. The method may include uploading and storing data about school facility floor plans, academic and non-academic rooms, academic schedules, student users, faculty and staff users, parent users, and visitor users to a remote server at 210. Further, the method may include configuring desktop, mobile, and dedicated hardware devices to become associated with rooms stored in the remote server at 220. Further, the method may include processing QR, Barcode, RFID, or identification via manual entry on devices in step B and transmitting this data, along with a timestamp, room association, and device information, to a remote server to be matched with users identified at 230. Further, the method may include confirming user activity, timestamp, and room information transmitted is associated with specific user data on the remote server to create a record of movement, and determine entry or exit from a given room at 240. Further, the method may include associating student user activity transmitted with academic schedule data identified to determine whether the student activity processed is an attendance-related action at 250. Further, the method may include transferring attendance data discovered to attendance records stored in one or more remote servers for use with student transcripts, reporting, and other academic functions at 260. Further, the method may include displaying user activity processed in a visualization demonstrating this data signifies movement across rooms and floor plans belonging to a school facility designated at 270. Further, the method may include notifying designated users when user movement data indicates an action that requires attention via SMS, push notification, email, and/or voice call methods as defined in preferences by the system administrator at 280. Further, the method may include transferring data from remote server back to devices to indicate a successful match for a user after processing data indicating a scan in or out of a room, and new academic schedule data from a remote server that is relevant to the device at 290.

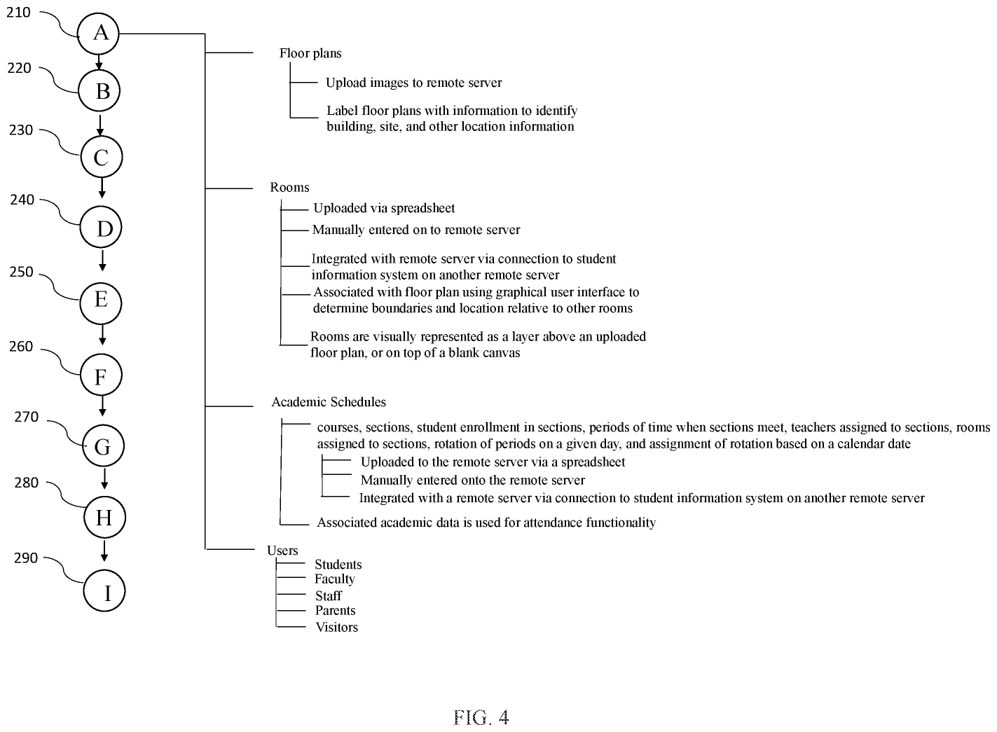

As shown in FIG. 4, the step A 210 may include a method for facilitating uploading information related to rooms, floor plans, users, schedules, and academic data of a school, in accordance with some embodiments. Accordingly, the method may include uploading and storing data about school facility floor plans, academic and non-academic rooms, academic schedules, student users, faculty and staff users, parent users, and visitor users to the remote server. Further, the floor plans may include images uploaded to the remote server. Further, the floor plans may include label floor plans with information to identify the building, site, and other location information. Further, information associated with the rooms may be uploaded via a spreadsheet. Further, the information associated with the rooms may be manually entered onto the remote server. Further, the information associated with the rooms may be integrated with the remote server via connection to the student information system on another remote server. Further, the information associated with the rooms may be associated with floor plans using a graphical user interface to determine boundaries and location relative to other rooms. Further, the rooms are visually represented as a layer above an uploaded floor plan, or on top of a blank canvas. Further, information associated with academic Schedules may include courses, sections, student enrollment in sections, periods of time when sections meet, teachers assigned to sections, rooms assigned to sections, rotation of periods on a given day, and assignment of rotation based on a calendar date. Further, the information associated with the academic schedules may be uploaded to the remote server via a spreadsheet. Further, the information associated with the academic schedules may be updated manually entered onto the remote server. Further, the information associated with the academic schedules may be integrated with the remote server via connection to the student information system on a second remote server. Further, associated academic data is used for attendance functionality. Further, the users may include students, faculty, staff, parents, visitors, etc.

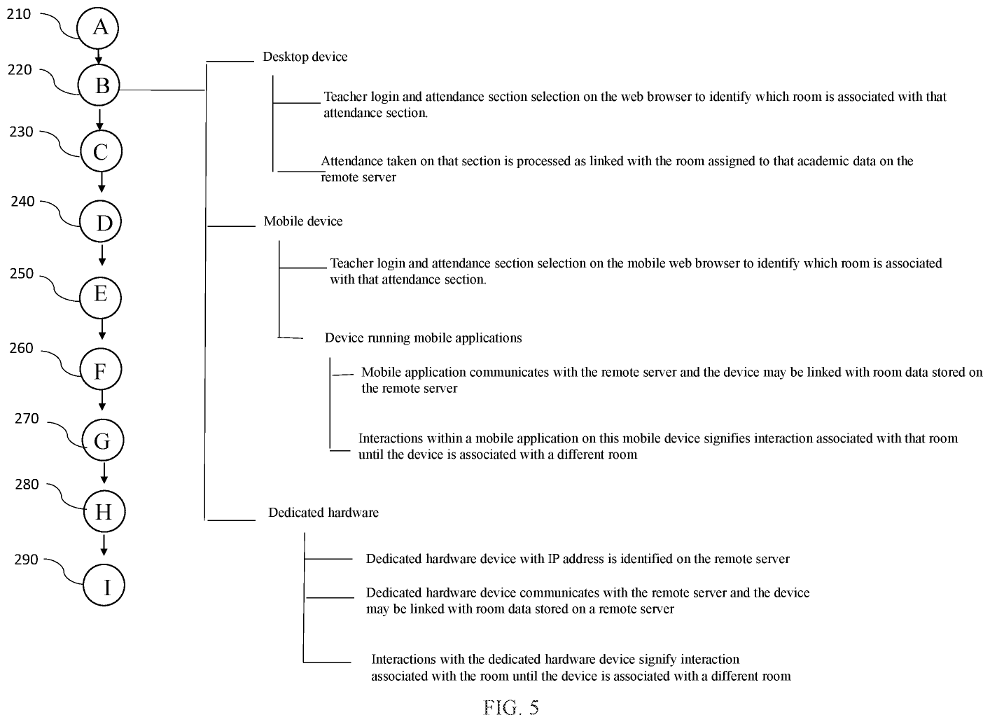

As shown in FIG. 5, the step B 220 may include a method illustrating the configuration of desktop, mobile, and hardware devices to be associated with rooms, in accordance with some embodiments. Accordingly, the method may include configuring desktop, mobile, and dedicated hardware devices to become associated with rooms stored in the remote server. Further, the desktop device may facilitate teacher login and attendance section selection on the web browser to identify which room is associated with that attendance section. Further, the attendance taken on that section is processed as linked with the room assigned to that academic data on the remote server. Further, the mobile device may include a device running a mobile web browser. Further, the mobile device may be configured for running mobile applications. Further, the mobile application communicates with the remote server and the device may be linked with room data stored on the remote server. Further, interactions within a mobile application on this mobile device signifies interaction associated with that room until the device is associated with a different room. Further, a dedicated hardware device associated with an IP address is identified on the remote. Further, the dedicated hardware device communicates with the remote server and the device may be linked with room data stored on a remote server. Further, the interactions with the dedicated hardware device signify interaction associated with the room until the device is associated with a different room.

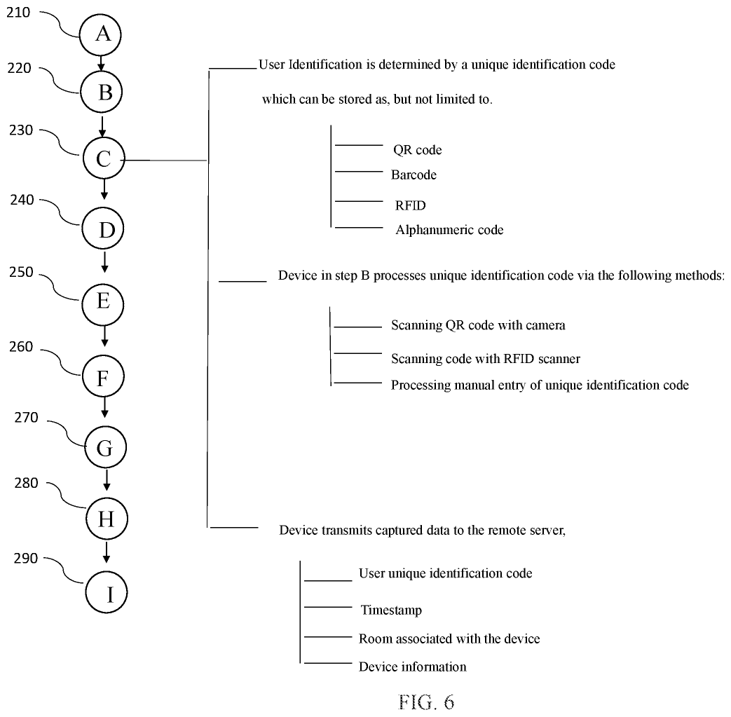

As shown in FIG. 6, the step C 230 may include a method for collecting data associated with the user and transmitting it to the remote server, in accordance with some embodiments. Accordingly, the method may include processing QR, Barcode, RFID, or identification via manual entry on the devices and transmitting this data, along with a timestamp, room association, and device information, to the remote server to be matched with users. Further, the user Identification is determined by a unique identification code, which can be stored as, but not limited to QR code, barcode, RFID, alphanumeric code. Further, the device, as described in FIG. 5, processes unique identification code (or code) via the following methods such as scanning code with camera, scanning code with RFID scanner, processing manual entry of unique identification code, etc. Further, the device transmits captured data to the remote server, user unique identification code, timestamp, room associated with the device, and device information.

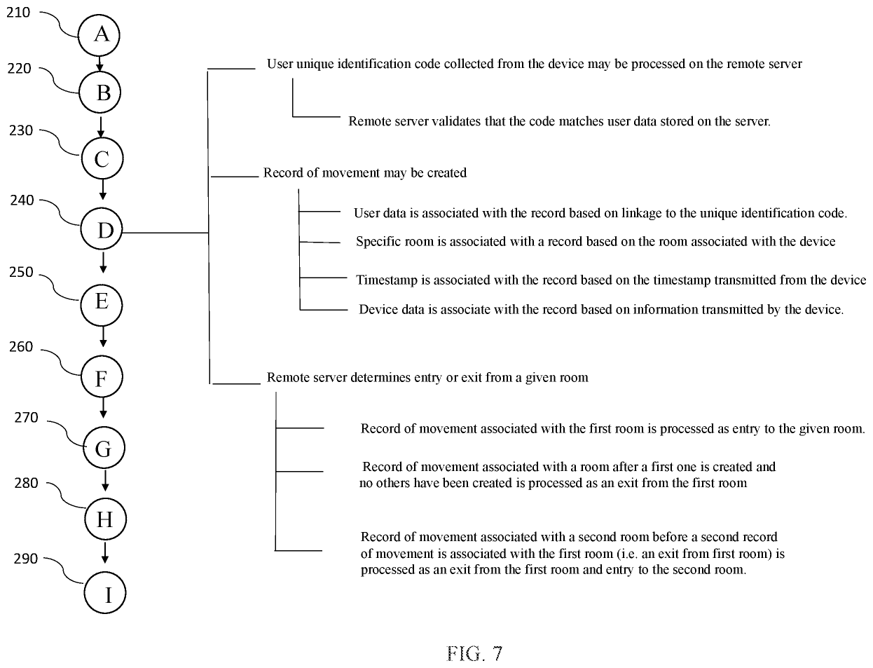

As shown in FIG. 7, the step D 240 includes a method for associating the unique identification code, timestamp, and room information transmitted to create a record of movement, and determine entry or exit from a given room, in accordance with some embodiments. Accordingly, the method may include confirming user activity, timestamp, and room information transmitted in step C is associated with specific user data on the remote server to create a record of movement and determine entry or exit from a given room. Further, the unique identification code (or user unique identification code) collected from the device may be processed on the remote server. Further, the remote server validates that the code matches user data stored on the server. Further, a record of movement may be created. Further, the user data is associated with the record based on linkage to the unique identification code. Further, the specific room is associated with a record based on the room associated with the device. Further, the timestamp is associated with the record based on the timestamp transmitted from the device. Further, the device data is associate with the record based on information transmitted by the device. Further, the remote server determines entry or exit from a given room. Further, the record of movement associated with the first room is processed as entry to the given room. Further, the record of movement associated with a room after a first one is created and no others have been created is processed as an exit from the first room. Further, the record of movement associated with a second room before a second record of movement is associated with the first room (i.e. an exit from first room) is processed as an exit from the first room and entry to the second room.

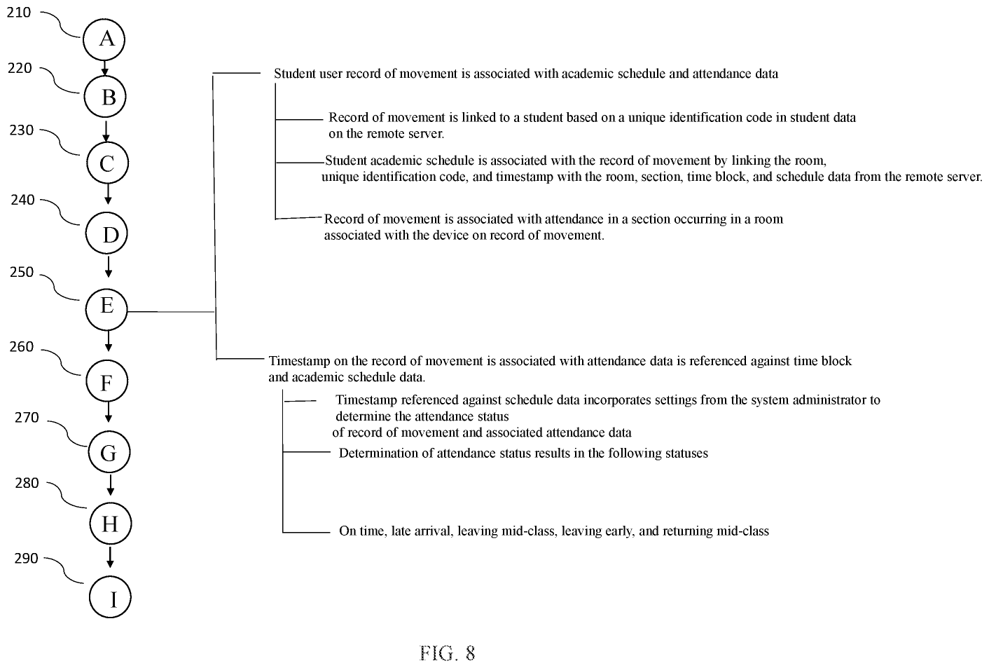

As shown in FIG. 8, the step E includes a method for facilitating the association of student movement data with the academic schedule data to determine whether the student activity processed is an attendance-related action, in accordance with some embodiments. Accordingly, the method may include associating student user activity transmitted in step D with academic schedule data identified to determine whether the student activity processed in step D is an attendance-related action. Further, the student user record of movement is associated with academic schedule and attendance data. Further, the record of movement is linked to a student based on a unique identification code in student data on the remote server. Further, the student academic schedule is associated with the record of movement by linking the room, unique identification code, and timestamp with the room, section, time block, and schedule data from the remote server. Further, the record of movement is associated with attendance in a section occurring in a room associated with the device on record of movement. Further, the timestamp on the record of movement is associated with attendance data is referenced against time block and academic schedule data. Further, the timestamp referenced against schedule data incorporates settings from the system administrator to determine the attendance status of record of movement and associated attendance data. Further, the method may include determination of attendance status results in the following statuses, such as, on time, late arrival, leaving mid-class, leaving early, and returning mid-class.

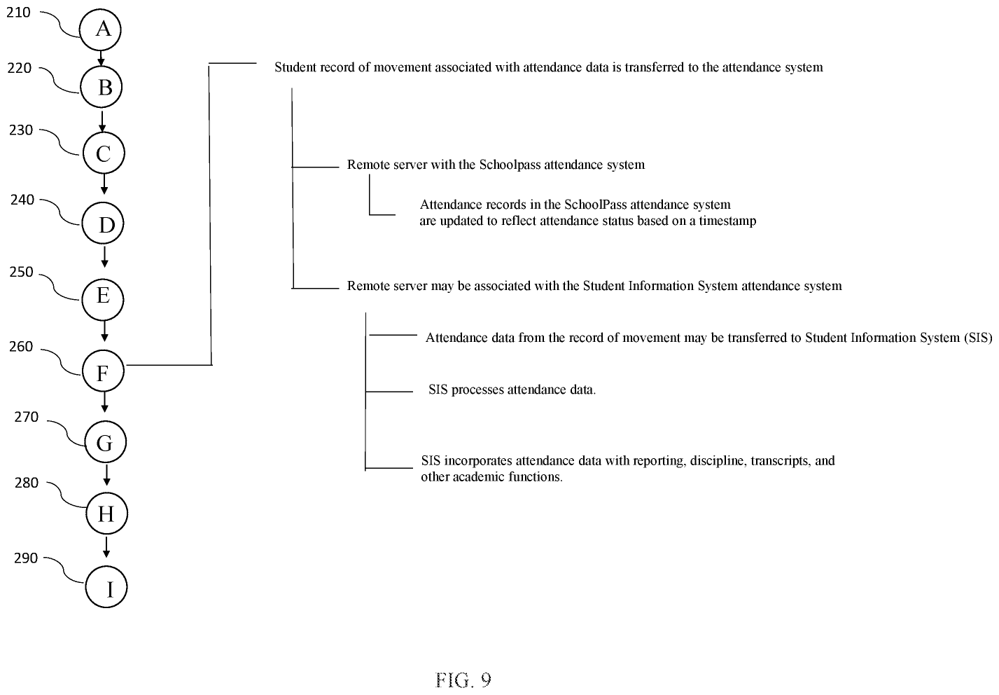

As shown in FIG. 9, the step F 250 includes a method for facilitating transferring of attendance data to attendance records stored in one or more remote servers for use with student transcripts, reporting, and other academic functions, in accordance with some embodiments. Accordingly, the method may include transferring the attendance data discovered in step E to the attendance records stored in one or more remote servers for use with student transcripts, reporting, and other academic functions. Further, the student record of movement associated with attendance data is transferred to the attendance system. Further, the attendance records in the SchoolPass attendance system are updated to reflect attendance status based on a timestamp. Further, the remote server may be associated with the Student Information System attendance system. Further, the attendance data from the record of movement may be transferred to Student Information System (SIS). Further, the SIS processes attendance data. Further, the SIS incorporates attendance data with reporting, discipline, transcripts, and other academic functions.

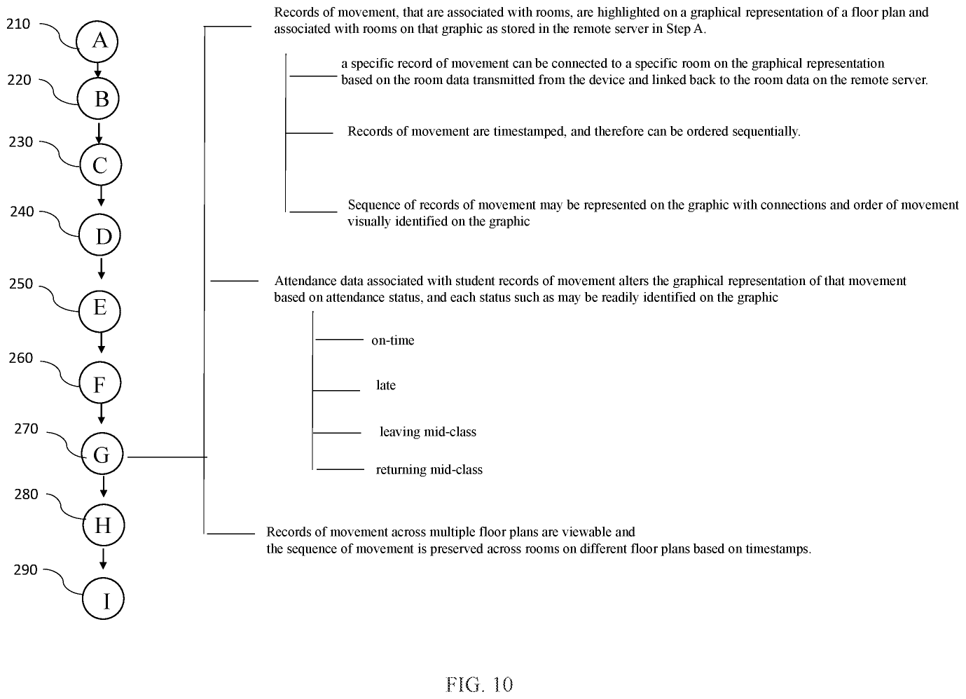

As shown in FIG. 10, the step G 270 includes a method for facilitating processing of the records of movement across rooms and floor plans to translate into a visual representation of movement across rooms and floor plans, in accordance with some embodiments. Accordingly, the method may include displaying user activity processed in step D in a visualization demonstrating this data signifies movement across rooms and floor plans belonging to a school facility designated in step A. Further, the records of movement, that are associated with rooms, are highlighted on a graphical representation of a floor plan and associated with rooms on that graphic as stored in the remote server in Step A. Further, a specific record of movement can be connected to a specific room on the graphical representation based on the room data transmitted from the device and linked back to the room data on the remote server. Further, the records of movement are timestamped, and therefore can be ordered sequentially. Further, the sequence of records of movement may be represented on the graphic with connections and order of movement visually identified on the graphic. Further, the attendance data associated with student records of movement alters the graphical representation of that movement based on attendance status, and each status such as on-time, late arrival, leaving mid-class, leaving early, returning mid-class, etc. may be readily identified on the graphic. Further, the records of movement across multiple floor plans are viewable and the sequence of movement is preserved across rooms on different floor plans based on timestamps.

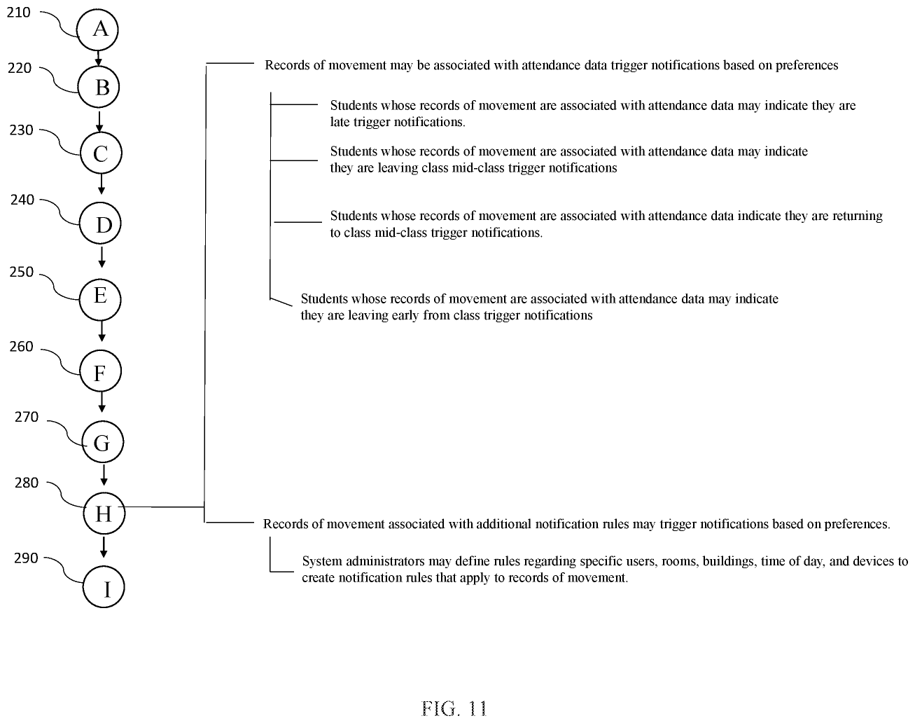

As shown in FIG. 11, the step H 280 includes a method for facilitating notifying designated users when user movement indicates an action that requires attention, in accordance with some embodiments. Accordingly, the method may include notifying designated users when user movement data indicates an action that requires attention via SMS, push notification, email, and/or voice call methods as defined in preferences by the system administrator. Further, the method may include notifying designated users when user movement data indicates an action that requires attention via SMS, push notification, email, and/or voice call methods as defined in preferences by the system administrator. Further, notification methods include SMS, push notifications, email, voice calls, etc. Further, the records of movement may be associated with attendance data trigger notifications based on preferences. Further, students whose records of movement are associated with attendance data may indicate they are late trigger notifications. Further, students whose records of movement are associated with attendance data may indicate they are leaving class mid-class trigger notifications. Further, students whose records of movement are associated with attendance data indicate they are returning to class mid-class trigger notifications. Further, students whose records of movement are associated with attendance data may indicate they are leaving early from class trigger notifications. Further, the records of movement associated with additional notification rules may trigger notifications based on preferences. Further, the system administrators may define rules regarding specific users, rooms, buildings, time of day, and devices to create notification rules that apply to records of movement.

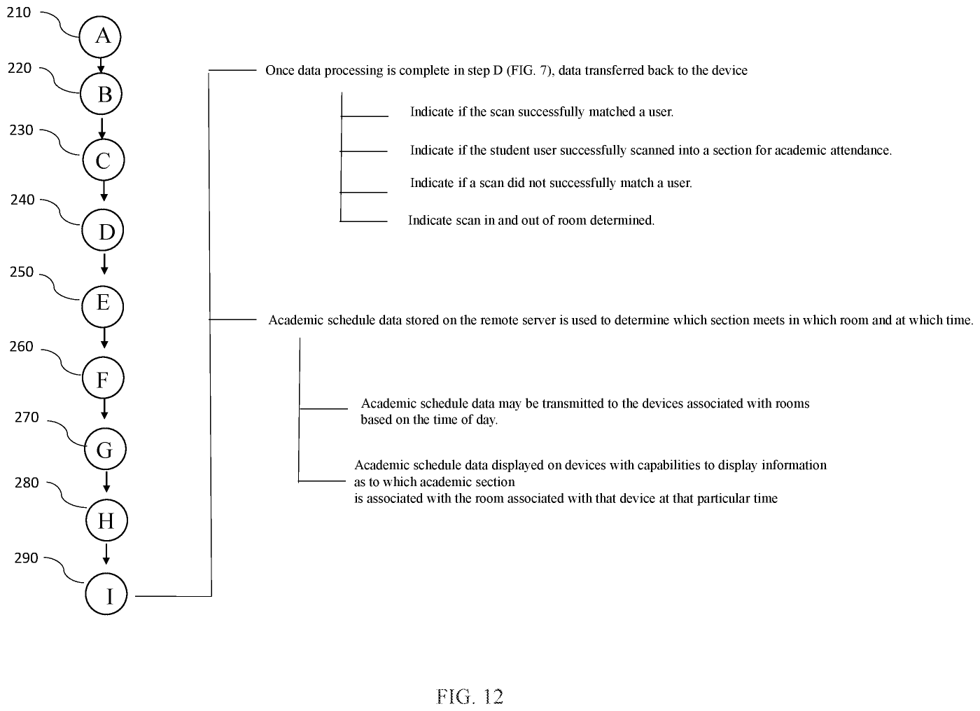

As shown in FIG. 12, the step I 290 includes a method for facilitating transferring of data from the remote server back to the devices in step B to indicate a successful match, in accordance with some embodiments. Accordingly, data may be transferred from the remote server back to devices in step B 250 (FIG. 5) to indicate a successful match for a user after processing data in step D 240 (FIG. 7), indicating a scan in or out of a room, and new academic schedule data from a remote server that is relevant to device. Further, the method may include transferring data from remote server back to devices in step B to indicate a successful match for a user after processing data in step D, indicating a scan in or out of a room, and new academic schedule data from the remote server that may be relevant to the user. Further, once data processing is complete in step D 240 (FIG. 7), data transferred back to the device may indicate if the scan successfully matched a user. Further, once data processing is complete in step D 240 (FIG. 7), data transferred back to the device may indicate if the student user successfully scanned into a section for academic attendance. Further, once data processing is complete in step D 240 (FIG. 7), data transferred back to the device may indicate if a scan did not successfully match a user. Further, once data processing is complete in step D 240 (FIG. 7), data transferred back to the device may indicate scan in and out of room determined. Further, the academic schedule data stored on the remote server is used to determine which section meets in which room and at which time. Further, the academic schedule data may be transmitted to the devices associated with rooms based on the time of day. Further, the academic schedule data displayed on devices with capabilities to display information as to which academic section is associated with the room associated with that device at that particular time.

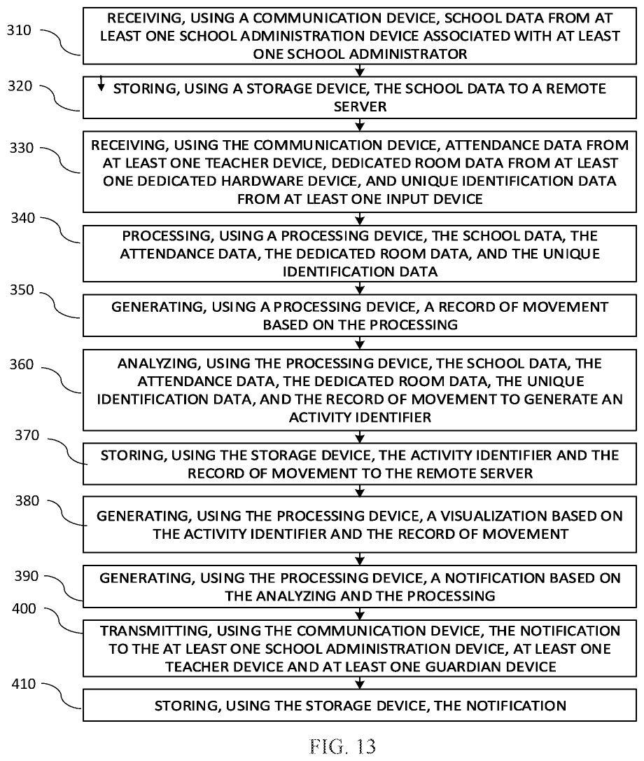

FIG. 13 is a flow chart of a method for facilitating managing student attendance and movement of individuals throughout a school facility 200, in accordance with some embodiments. Accordingly, the method 200 may include receiving, using a communication device, school data from at least one school administration device associated with at least one school administrator at 310. Further, the at least one school administrator may include an individual, an institution, and an organization that may want to upload the school data. Further, the school data may include information associated with school facility floor plans, academic and non-academic rooms, academic schedules, etc. Further, the school data may include user data comprising information associated with student users, faculty and staff users, parent users, and visitor users. Further, the at least one school administration device may include a laptop, a smartphone, a tablet, a personal computer, and so on.

Further, the method may include storing, using a storage device, the school data to a remote server at 320.

Further, the method may include receiving, using the communication device, attendance data from at least one teacher device, dedicated room data from at least one dedicated hardware device, and unique identification data from at least one input device at 330. Further, the at least one school teacher device may include a laptop, a smartphone, a tablet, a personal computer, and so on. Further, the at least one hardware device may be associated with at least one of the school facility floor plans, the academic room, and the non-academic rooms. Further, the at least one input device may be configured for identifying at least one user (such as a student, a teacher, a visitor, etc.). Further, the at least one input device may include an RFID reader, a camera, etc. Further, the unique identification data may include unique identification codes corresponding to each of the at least one user.

Further, the method may include processing, using a processing device, the school data, the attendance data, the dedicated room data, and the unique identification data at 340.

Further, the method may include generating, using a processing device, a record of movement based on the processing at 350. Further, the record of movement may facilitate determining the entry or exit of the student from a room.

In some embodiments, the record of movement may include a record of the exit when the entry to another room occurs after the entry to the room. For example, when a student enters a first room, the entry to the first room can be recorded. And when the student exits and enters a second room, the entry to the second room can be recorded and also the exit of the first room can be recorded when the entry to the second room is recorded. As noted above, if a user scans into one room, and forgets to scan out, then scans into a second room, the present invention may mark the time that the user scanned into the second room as “automatic scan out time” from the first room.

Further, the user data may be associated with the record of movement based on linkage to the unique identification code. Further, the room (or a specific room) may be associated with the record of movement based on room information associated with the dedicated hardware device. Further, the school data may include the room information. Further, a timestamp (associated with the dedicated room data) may be associated with the record of movement based on the timestamp transmitted from the dedicated hardware device. Further, device data (associated with the dedicated room data) may be associated with the record of movement based on information transmitted by the dedicated hardware device.

Further, the method may include analyzing, using the processing device, the school data, the attendance data, the dedicated room data, the unique identification data, and the record of movement to generate an activity identifier at 360. Further, the activity identifier may confirm if the student activity is an attendance-related activity. Further, the activity identifier may facilitate the determination of attendance status result comprising on time, late arrival, leaving mid class, leaving early, returning mid class, etc.

Further, the method may include storing, using the storage device, the activity identifier, and the record of movement to the remote server at 370.

Further, the method may include generating, using the processing device, a visualization based on the activity identifier and the record of movement at 380. Further, the visualization may include a graphical representation signifying movement (or the student activity) across rooms and floor plans belonging to a school facility (or the school). Further, the record of movement across multiple floor plans is viewable and the sequence of movement is preserved across rooms on different floor plans based on the timestamp.

Further, the method may include generating, using the processing device, a notification based on the analyzing and the processing at 390. Further, the notification may facilitate notifying at least one of the school administrations and the parents. Further, the notification may include at least one of the record of movement and the activity identifier. Further, the notification may include the visualization.

Further, the method may include transmitting, using the communication device, the notification to the at least one school administration device, the at least one teacher device, and at least one guardian device at 400. Further, the at least one guardian device may include a laptop, a smartphone, a tablet, a personal computer, and so on. Further, the at least one guardian may include an individual such as a parent or a relative that may want to receive the notification.

Further, the method may include storing, using the storage device, the notification at 410.

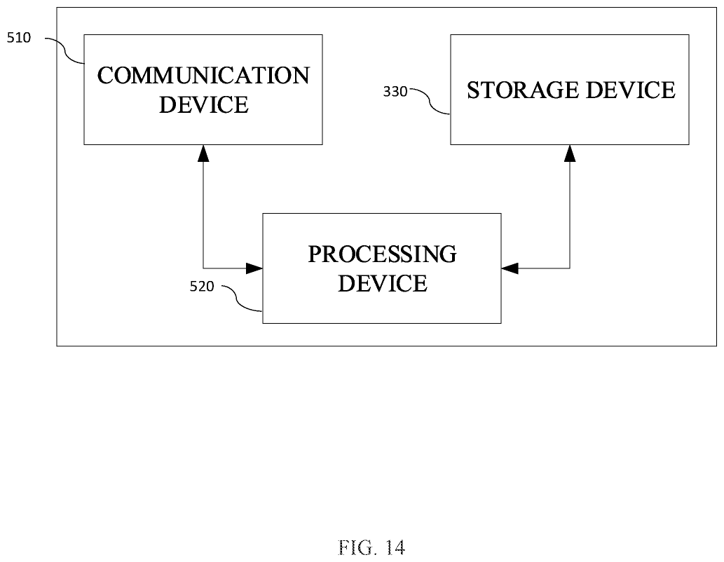

FIG. 14 is a block diagram of a system for facilitating managing student attendance and movement of individuals throughout a school facility 200, in accordance with some embodiments. Accordingly, the system may include a communication device 510 configured for receiving school data from at least one school administration device associated with at least one school administrator. Further, the at least one school administrator may include an individual, an institution, and an organization that may want to upload the school data. Further, the school data may include information associated with school facility floor plans, academic and non-academic rooms, academic schedules, etc. Further, the school data may include user data comprising information associated with student users, faculty and staff users, parent users, and visitor users. Further, the at least one school administration device may include a laptop, a smartphone, a tablet, a personal computer, and so on. Further, the communication device may be configured for receiving attendance data from at least one teacher device, dedicated room data from at least one dedicated hardware device, and unique identification data from at least one input device. Further, the at least one teacher device may include a laptop, a smartphone, a tablet, a personal computer, and so on. Further, the at least one hardware device may be associated with at least one of the school facility floor plans, the academic room and the non-academic rooms. Further, the at least one input device may be configured for identifying at least one user (such as a student, a teacher, a visitor, etc.). Further, the at least one input device may include an RFID reader, a camera, etc. Further, the unique identification data may include unique identification codes corresponding to each of the at least one user. Further, the communication device may be configured for transmitting a notification to the at least one school administration device, the at least one teacher device, and at least one guardian device. Further, the at least one guardian device may include a laptop, a smartphone, a tablet, a personal computer, and so on. Further, the at least one guardian may include an individual such as a parent or relative that may want to receive the notification.

Further, the system may include a processing device 520 configured for processing the school data, the attendance data, the dedicated room data, and the unique identification data. Further, the processing device may be configured for generating the record of movement based on the processing. Further, the record of movement may facilitate determining the entry or exit of the student from a room. Further, the user data may be associated with the record of movement based on linkage to the unique identification code. Further, the room (or a specific room) may be associated with the record of movement based on room information associated with the dedicated hardware device. Further, the school data may include the room information. Further, a timestamp (associated with the dedicated room data) may be associated with the record of movement based on a timestamp transmitted from the dedicated hardware device. Further, device data (associated with the dedicated room data) may be associated with the record of movement based on information transmitted by the dedicated hardware device. Further, the processing device may be configured for analyzing the school data, the attendance data, the dedicated room data, the unique identification data, and the record of movement to generate the activity identifier. Further, the activity identifier may confirm if the student activity is an attendance-related activity. Further, the activity identifier may facilitate determination of attendance status result comprising on time, late arrival, leaving mid class, leaving early, returning mid class, etc. Further, the processing device may be configured for generating the visualization based on the activity identifier and the record of movement. Further, the visualization may include a graphical representation signifying movement (or the student activity) across rooms and floor plans belonging to a school facility (or the school). Further, the record of movement across multiple floor plans is viewable and the sequence of movement is preserved across rooms on different floor plans based on the timestamp. Further, the processing device may be configured for generating the notification based on the analyzing and the processing. Further, the notification may facilitate notifying at least one of the school administrations and the parents. Further, the notification may include at least one of the record of movements and the activity identifier. Further, the notification may include the visualization.

Further, the system may include a storage device 530 configured for storing the school data to a remote server. Further, the storage device may be configured for storing the notification. Further, the storage device may be configured for storing the activity identifier and the record of movement to the remote server.

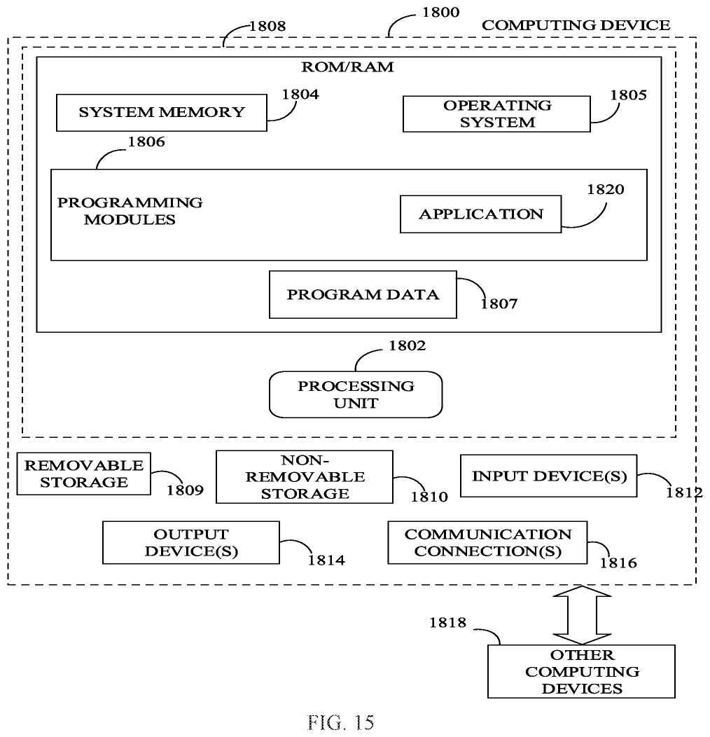

With reference to FIG. 15, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random-access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 15 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 15 by a removable storage 1809 and a non-removable storage 1810. Computer storage media may include volatile and nonvolatile, removable and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, a location sensor, a camera, a biometric sensor, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1804, including operating system 1805. While executing on processing unit 1802, programming modules 1806 (e.g., application 1820 such as a media player) may perform processes including, for example, one or more stages of methods, algorithms, systems, applications, servers, databases as described above. The aforementioned process is an example, and processing unit 1802 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method comprising:
receiving, using a communication device, school data from at least one school administration device associated with at least one school administrator, the school data includes information associated with school facility floor plans, academic and non-academic rooms, and academic schedules;
storing, using a storage device, the school data to a remote server;
receiving, using the communication device, attendance data from at least one teacher device, dedicated room data from at least one dedicated hardware device, and unique identification data from at least one input device, wherein the unique identification data includes unique identification codes corresponding to each user, wherein the at least one dedicated hardware device is associated with at least one of the school facility floor plans, the academic room, and the non-academic rooms;
processing, using a processing device, the school data, the attendance data, the dedicated room data, and the unique identification data;
generating, using a processing device, a record of movement based on the processing, wherein the record of movement facilitates determining an entry or an exit of the student from a room, where the exit is recorded when the entry to another room occurs after the entry to the room, the record of movement is associated with a timestamp transmitted from the dedicated hardware device, the record of movement is associated with device data based on information transmitted by the dedicated hardware device;
analyzing, using the processing device, the school data, the attendance data, the dedicated room data, the unique identification data, and the record of movement to generate an activity identifier, wherein the activity identifier confirms if the student activity is an attendance-related activity, wherein the activity identifier facilitates the determination of attendance status result comprising on time, late arrival, leaving mid class, leaving early, and returning mid class;
storing, using the storage device, the activity identifier and the record of movement to the remote server;
generating, using the processing device, a visualization based on the activity identifier and the record of movement;
generating, using the processing device, a notification based on the analyzing and the processing, wherein the notification includes at least one of the record of movement and the activity identifier, wherein the notification includes the visualization;
transmitting, using the communication device, the notification to the at least one school administration device, the at least one teacher device, and at least one guardian device; and
storing, using the storage device, the notification.

2. The method as claimed in claim 1, wherein the school data includes user data comprising information associated with student users, faculty and staff users, parent users, and visitor users.

3. The method as claimed in claim 1, wherein the at least one input device is configured for identifying at least one user.

4. The method as claimed in claim 1, wherein the at least one input device includes an RFID reader, and a camera.

5. The method as claimed in claim 1, wherein the school data includes the room information.

6. The method as claimed in claim 1, wherein the visualization includes a graphical representation signifying the student activity across rooms and floor plans belonging to a school facility.

7. The method as claimed in claim 1, wherein the visualization includes the record of movement across multiple floor plans that is viewable and the sequence of movement that is preserved across rooms on different floor plans based on the timestamp.

8. A method comprising:
receiving, using a communication device, school data from at least one school administration device associated with at least one school administrator, the school data includes information associated with school facility floor plans, academic and non-academic rooms, and academic schedules;
storing, using a storage device, the school data to a remote server;
receiving, using the communication device, attendance data from at least one teacher device, dedicated room data from at least one dedicated hardware device, and unique identification data from at least one input device, wherein the unique identification data includes unique identification codes corresponding to each user, wherein the at least one dedicated hardware device is associated with at least one of the school facility floor plans, the academic room, and the non-academic rooms;
processing, using a processing device, the school data, the attendance data, the dedicated room data, and the unique identification data;
generating, using a processing device, a record of movement based on the processing, wherein the record of movement facilitates determining an entry or an exit of the student from a room, where the exit is recorded when the entry to another room occurs after the entry to the room, the record of movement is associated with a timestamp transmitted from the dedicated hardware device, the record of movement is associated with device data based on information transmitted by the dedicated hardware device;
analyzing, using the processing device, the school data, the attendance data, the dedicated room data, the unique identification data, and the record of movement to generate an activity identifier, wherein the activity identifier confirms if the student activity is an attendance-related activity, wherein the activity identifier facilitates the determination of attendance status result comprising on time, late arrival, leaving mid class, leaving early, and returning mid class;
storing, using the storage device, the activity identifier and the record of movement to the remote server;
generating, using the processing device, a visualization based on the activity identifier and the record of movement, wherein the visualization includes a graphical representation signifying the student activity across rooms and floor plans belonging to a school facility;
generating, using the processing device, a notification based on the analyzing and the processing, wherein the notification includes at least one of the record of movement and the activity identifier, wherein the notification includes the visualization;
transmitting, using the communication device, the notification to the at least one school administration device, the at least one teacher device, and at least one guardian device; and
storing, using the storage device, the notification.

9. The method as claimed in claim 8, wherein the school data includes user data comprising information associated with student users, faculty and staff users, parent users, and visitor users.

10. The method as claimed in claim 8, wherein the at least one input device is configured for identifying at least one user.

11. The method as claimed in claim 8, wherein the at least one input device includes an RFID reader, and a camera.

12. The method as claimed in claim 8, wherein the school data includes the room information.

13. The method as claimed in claim 8, wherein the visualization includes the record of movement across multiple floor plans that is viewable and the sequence of movement that is preserved across rooms on different floor plans based on the timestamp.

14. A non-transitory computer readable medium containing computer-readable instructions stored therein for causing a computer processor to perform operations to:
receive, using a communication device, school data from at least one school administration device associated with at least one school administrator, the school data includes information associated with school facility floor plans, academic and non-academic rooms, and academic schedules;
store, using a storage device, the school data to a remote server;
receive, using the communication device, attendance data from at least one teacher device, dedicated room data from at least one dedicated hardware device, and unique identification data from at least one input device, wherein the unique identification data includes unique identification codes corresponding to each user, wherein the at least one dedicated hardware device is associated with at least one of the school facility floor plans, the academic room, and the non-academic rooms;
process, using a processing device, the school data, the attendance data, the dedicated room data, and the unique identification data;
generate, using a processing device, a record of movement based on the process, wherein the record of movement facilitates determining an entry or an exit of the student from a room, where the exit is recorded when the entry to another room occurs after the entry to the room, the record of movement is associated with a timestamp transmitted from the dedicated hardware device, the record of movement is associated with device data based on information transmitted by the dedicated hardware device;
analyze, using the processing device, the school data, the attendance data, the dedicated room data, the unique identification data, and the record of movement to generate an activity identifier, wherein the activity identifier confirms if the student activity is an attendance-related activity, wherein the activity identifier facilitates the determination of attendance status result comprising on time, late arrival, leaving mid class, leaving early, and returning mid class;
store, using the storage device, the activity identifier and the record of movement to the remote server;
generate, using the processing device, a visualization based on the activity identifier and the record of movement;
generate, using the processing device, a notification based on the analyzing and the processing, wherein the notification includes at least one of the record of movement and the activity identifier, wherein the notification includes the visualization;
transmit, using the communication device, the notification to the at least one school administration device, the at least one teacher device, and at least one guardian device; and
store, using the storage device, the notification.

15. The non-transitory computer readable medium as claimed in claim 14, wherein the school data includes user data comprising information associated with student users, faculty and staff users, parent users, and visitor users.

16. The non-transitory computer readable medium as claimed in claim 14, wherein the at least one input device is configured for identifying at least one user.

17. The non-transitory computer readable medium as claimed in claim 14, wherein the at least one input device includes an RFID reader, and a camera.

18. The non-transitory computer readable medium as claimed in claim 14, wherein the school data includes the room information.

19. The non-transitory computer readable medium as claimed in claim 14, wherein the visualization includes a graphical representation signifying the student activity across rooms and floor plans belonging to a school facility.

20. The non-transitory computer readable medium as claimed in claim 14, wherein the visualization includes the record of movement across multiple floor plans that is viewable and the sequence of movement that is preserved across rooms on different floor plans based on the timestamp.
